(19) United States
(12) Patent Application Publication
(10) Pub. No.: US 2014/0138443 A1
(43) Pub. Date: May 22, 2014

(54) TRANSACTION CARD

(71) Applicant: BLACK CARD LLC, Jackson, WY (US)

(72) Inventor: Scott Alan Blum, Jackson, WY (US)

(73) Assignee: Black Card LLC, Jackson, WY (US)

(21) Appl. No.: 13/830,623

(22) Filed: Mar. 14, 2013

Related U.S. Application Data
(60) Provisional application No. 61/729,214, filed on Nov. 21, 2012.

(51) Int. Cl. G06K 19/02

(52) U.S. Cl. CPC G06K 19/02
USPC 235/487; 156/277

(57) ABSTRACT

A transaction card comprising a plurality of metal flakes suspended in a non-metallic matrix.

### CROSS-REFERENCE TO RELATED APPLICATION

This application claims priority to provisional application Ser. No. 61/729,214, filed on Nov. 21, 2012, the entire contents of which are hereby incorporated by reference.

### TECHNICAL FIELD

The present invention relates to transaction cards. such as credit cards and debit cards, that are used as substitutes for cash.

### DESCRIPTION OF RELATED ART

The vast majority of transaction cards in use today are constructed of plastic. These cards tend to be flimsy and wear out or break easily.

### SUMMARY

The preferred embodiments of the present transaction card have several features, no single one of which is solely responsible for their desirable attributes. Without limiting the scope of the present embodiments as expressed by the claims that follow, their more prominent features will now be discussed briefly. After considering this discussion, and particularly after reading the section entitled “Detailed Description of the Preferred Embodiments,” one will understand how the features of the present embodiments provide advantages, which include increased weight, enhanced feel, and high tech look.

One embodiment of the present carbon transaction card comprises a substantially planar sheet having a front surface, a hack surface and a continuous peripheral edge. The planar sheet comprises a plurality of metal flakes suspended in a non-metallic matrix.

### BRIEF DESCRIPTION OF THE DRAWINGS

The preferred embodiments of the present invention will now be discussed in detail with an emphasis on highlighting the advantageous features. These embodiments depict the novel and non-obvious invention shown in the accompanying drawings. Which are for illustrative purposes only. These drawings include the following figures, in which like numerals indicate like parts:

FIG. 1 is a front elevation view of one embodiment of the present transaction card;

FIG. 2 is a rear elevation view of the transaction card of FIG. 1; and

FIG. 3 is a detail view of the portion of the transaction card of FIG. 1 indicated by the circle 3-3.

### DETAILED DESCRIPTION

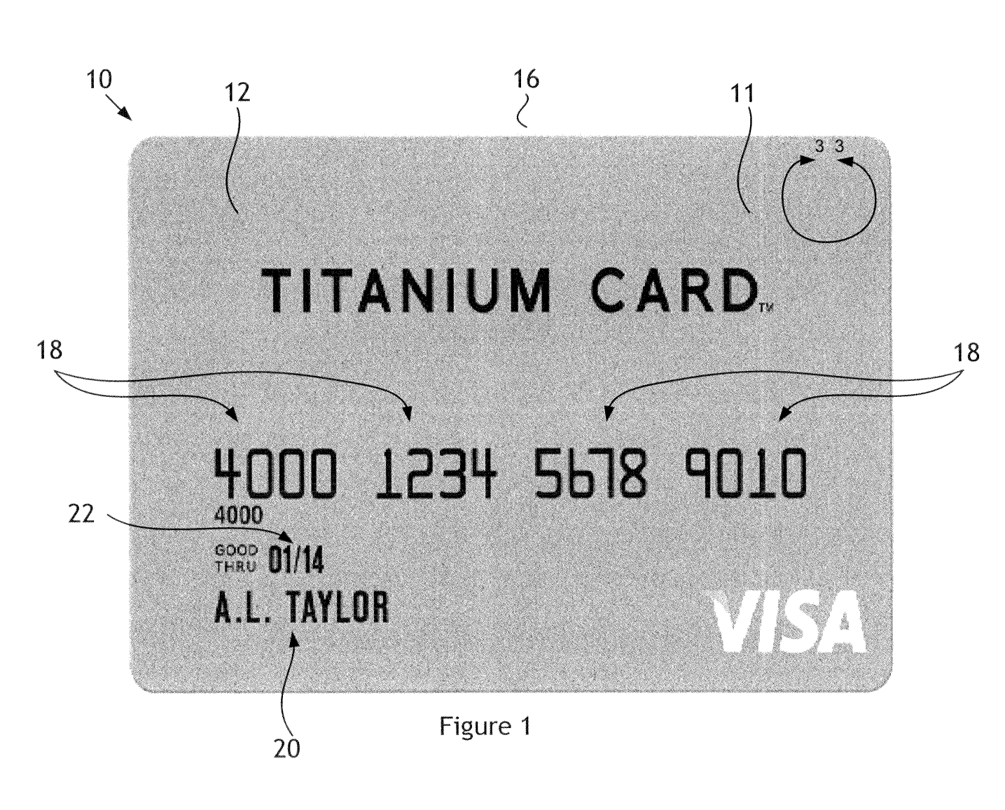

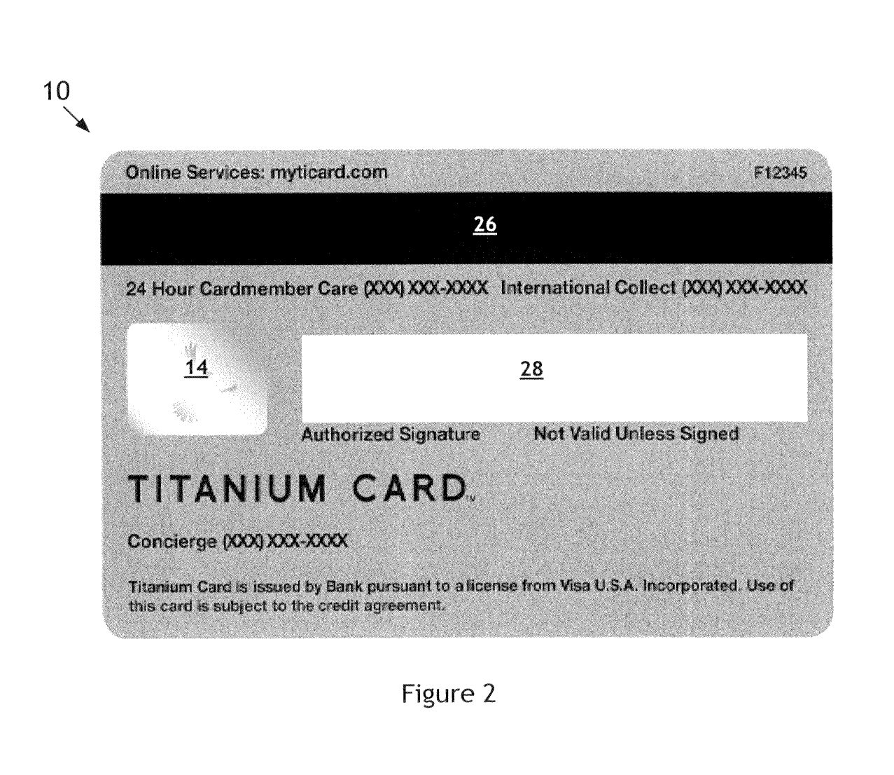

With reference to FIGS. 1 and 2, the present transaction card 10 is a substantially planar sheet 11 having a front surface 12 and a back surface 14. The card 10 includes a continuous peripheral edge 16, which in the illustrated embodiment is substantially rectangular. However, those of ordinary skill in the art will appreciate that the card 10 could have virtually any shape, such as square, round or hexagonal. The scope of the present card 10 is not limited to any particular shape.

In the illustrated embodiment, the transaction card 10 bears a number 18 (FIG. 1) that identifies the card 10 as being associated with a particular account. In the illustrated embodiment, the account number 18 has sixteen digits. However, in alternative embodiments the card 10 may have fewer or more digits. The card 10 also hears the name 20 of the cardholder and an expiration date 22. In certain embodiments, the card 10 may also bear a year 24 or date on which the cardholder first acquired the card 10. The information displayed on the card 10 may be applied in a conventional manner, such as embossing and or printing.

With reference to FIG. 2, the back surface 14 of the present transaction card 10 includes a magnetic strip 26. The magnetic strip 26 stores information that is readable by a magnetic reader. For example, the magnetic strip 26 may contain a series of digits from which the magnetic card reader can obtain information about the account associated with the card 10 and/or the cardholder. The back surface 14 of the present transaction card 10 further includes a signature panel 28.

While not shown in the figures, other embodiments of the present transaction card 10 may include additional features, such as an embedded microchip, a holographic image, etc. The card 10 may further include one or more transparent portions. Such transparent portions may include one or more optically recognizable layers or infrared-blocking ink to allow the transparent portion(s) to be recognized by an optical card reader. These additional features may allow the transaction card 10 to function more easily, efficiently, and/or more securely.

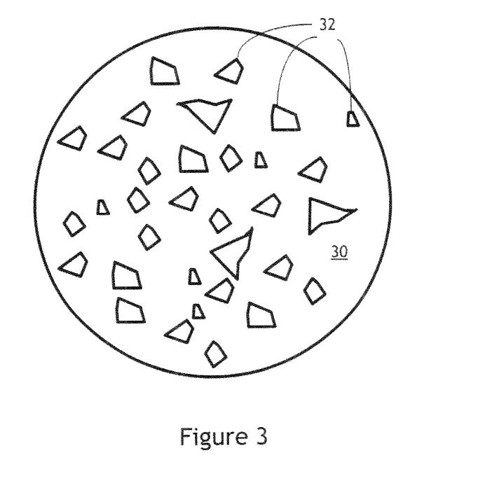

With reference to FIG. 3, the planar sheet 11 comprises a matrix 30 in which a plurality of metal flakes 32 are suspended or embedded. The metal flakes 32 may have any size and packing density. FIG. 3 is not intended to he drawn to scale.

The matrix 30 may comprise any non-metallic material, such as a polymer. A non-exhaustive and non-limiting list of example polymers includes polyethylene, polyethylene terephthalate, polypropylene, polystyrene, polytetrafluoroethylene, polyvinylchloride (PVC), polychlorotrifluoroethylene, polyacrylonitrile, polychloroprene, polyurethane, polyamide (nylon), and polyacrylamide. Other example materials for the matrix 30 include carbon, carbon graphite, or carbon fiber. The metal flakes 32 may comprise any metal and/or metal alloy. The metal flakes 32 may also comprise a mixture in which some particles are a first metal or alloy and some particles are a second metal or alloy, or a third or fourth etc. metal or alloy. A non-exhaustive and non-limiting list of example metals and metal alloys includes scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, aluminum, gallium, indium, thallium, lead, bismuth, tin, stainless steel, bronze, brass, and any combination(s) of the foregoing,

The vast majority of today's transaction cards are constructed of plastic. The present transaction card 10 is advantageously is heavier than a typical transaction card due to its metal content. The additional weight gives the card greater heft, which many consumers may find attractive. In addition to these benefits, the metal flakes 32 provide the card 10 with a unique feel and high tech look. The card 10 is thus more desirable for its distinctiveness over a typical plastic card.

The above description presents the best mode contemplated for carrying out the present invention, and of the manner and process of making and using it, in such full, clear, concise, and exact terms as to enable an person skilled in the art to Which it pertains to make and use this invention. This invention is, however, susceptible to modifications and alternate constructions from that discussed above that are fully equivalent. Consequently, this invention is not limited to the particular embodiments disclosed. On the contrary, this invention covers all modifications and alternate constructions coming within the spirit and scope of the invention as generally expressed by the following claims, which particularly point out and distinctly claim the subject matter of the invention.

What is claimed is:

1. A transaction card, comprising:
a substantially planar sheet having a front surface, a back surface and a continuous peripheral edge;
wherein the planar sheet comprises a plurality of metal flakes suspended in a non-metallic matrix.

2. The transaction card of claim 1, wherein the matrix a polymer.

3. The transaction card of claim 2, wherein the polymer is polyethylene, polyethylene terephthalate, polypropylene, polystyrene, polytetrafluoroethylene, polyvinylchloride (PVC), polychlorotrifluoroethylene, polyacrylonitrile, polychloroprene, polyurethane, polyamide (nylon), or polyacrylamide.

4. The transaction card of claim 1, wherein the matrix is carbon, carbon graphite, or carbon fiber.

5. The transaction card of claim 1, wherein the metal flakes comprise a mixture in which some particles are a first metal or alloy and some particles are a second metal or alloy.

6. A process of making a transaction card, the method comprising:
embedding a plurality of metal flakes in a non-metallic matrix of the card;
applying a number to the card that identifies the card as being associated with a particular account;
applying a name and an expiration date to the card; and
applying a magnetic strip to the card, the magnetic strip storing information that is readable by a magnetic reader.

7. The process of claim 6, wherein applying a number to the card comprises embossing or printing.

8. The process of claim 6, wherein the matrix a polymer.

9. The process of claim 8, wherein the polymer is polyethylene, polyethylene terephthalate, polypropylene, polystyrene, polytetrafluoroethylene, polyvinylchloride (PVC), polychlorotrifluoroethylene, polyacrylonitrile, polychloroprene, polyurethane, polyamide (nylon), or polyacrylamide.

10. The process of claim 6, wherein the matrix is carbon, carbon graphite, or carbon fiber.

11. The process of claim 6, wherein the metal flakes comprise a mixture in which some particles are a first metal or alloy and some particles are a second metal or alloy.
